(19) United States
(12) Patent Application Publication
(10) Pub. No.: US 2021/0107210 A1
(43) Pub. Date: Apr. 15, 2021

(54) ADDITIVE METHOD OF PRODUCING MOLDED BODIES

(71) Applicant: WACKER CHEMIE AG, Munich (DE)

(72) Inventor: Torsten GOTTSCHALK-GAUDIG, Mehring (DE)

(73) Assignee: WACKER CHEMIE AG, Munich (DE)

(21) Appl. No.: 17/041,275

(22) PCT Filed: Mar. 28, 2018
(86) PCT No.: PCT/EP2018/057933

§ 371 Date: Sep. 24, 2020

(51) Int. Cl. B29C 64/112; B29C 64/232; B29C 64/236; B29C 64/40; B29C 64/245; B29C 64/209; B33Y 70/00

(52) U.S. Cl. CPC B29C 64/112; B29C 64/232; B29C 64/236; B33Y 10/00; B29C 64/245; B29C 64/209; B33Y 70/00; B29C 64/40

(57) ABSTRACT

Accurate 3D printing is achieved by depositing a support material containing a polyether and a particulate rheological additive onto a substrate from a fixed applicator, the substrate being moveable.

### CROSS REFERENCE TO RELATED APPLICATIONS

This application is the U.S. National Phase of PCT Appln. No. PCT/EP2018/057933 filed Mar. 28, 2018, the disclosure of which incorporated in entirety by reference herein.

### BACKGROUND OF THE INVENTION

### 1. Field of the Invention

The invention relates to an additive process for producing three-dimensional shaped bodies which is characterized in that the shaped body is constructed in stepwise fashion by site-specific application of the structure-forming material in liquid form, wherein a second material is additionally applied as a support material in regions that are to remain free of structure-forming material and removed after solidification of the structure-forming material. Application of the support material via a fixed application unit onto a base plate positionable in the x, y and z direction allows fast, simple and cost-effective production of shaped articles of elevated quality.

### 2. Description of the Related Art

Additive manufacturing methods are available for numerous materials and combinations thereof (e.g. metals, plastics, ceramics, glasses).

Different processing methods are available for the production of shaped bodies by the site-specific application of a liquid structure-forming material (SFM).

In the case of highly viscous or pasty SFM, these may be applied in the form of a bead by means of a nozzle and deposited in a site-specific manner. Application by nozzle may be effected by means of pressure or using an extruder for example. A typical example of this processing method is 3D filament printing. A further known process is based on the ballistic metering of small amounts of SFM in the form of droplets that are applied in a site-specific manner by means of printheads. In the case of low-viscosity inks having zero or near-zero shear thinning, the process is called inkjet printing; in the case of higher-viscosity, shear-thinning materials, the term “jetting” is in common use.

A prerequisite for all additive manufacturing methods is the representation of the geometry and of any further properties (color, material composition) of the desired shaped body in the form of a digital 3D dataset which can be understood as a virtual model of the shaped body (A. Gebhardt, Generative Fertigungsverfahren [Additive Manufacturing Methods], Carl Hanser Verlag, Munich 2013). This modeling is preferably effected by means of various 3D-CAD (computer-aided design) construction methods. Input data used for the creation of a 3D-CAD model may also be 3D measurement data, resulting for example from CT (computer tomography) measurements or MRT (magnetic resonance tomography) measurements. The 3D-CAD dataset subsequently has to be supplemented with material-, process- and apparatus-specific data, which is accomplished by transmitting them via an interface in a suitable format (for example STL, CLI/SLC, PLY, VRML, AMF format) to an additive manufacturing software package. This software ultimately uses the geometric information to generate virtual slices, taking account of the optimal orientation of the component in the construction space, support structures etc. The full dataset then allows for direct control of the machine used for the additive manufacture (3D printer).

The software procedure is as follows:

1. Construction of the component in CAD format

2. Export into STL data format

3. Division of the 3D model into slices parallel to the printing plane and generation of the GCode

4. Transmission of the GCode to the printer controller

Common to all additive manufacturing methods with site-specific application of the SFM is the need for support structures in regions of cavities, undercuts and overhangs, since the site-specific application of the SFM always requires a supporting surface until the SFM has hardened. Such support materials (SM) for producing auxiliary structures are known.

US 2015/0028523 A1 describes the use of a thermoplastic polymer based on polyglycolic acid as an SM for filament printing. Disadvantageous here is that the thermoplastic SM must be heated to high temperatures of 200° C. or more and that, for example, an aqueous alkaline solution is needed to remove the SM.

US 2013/0337277 A1 describes the use of radiation-crosslinking block copolymers e.g. based on acrylated polyethylene glycol-polycaprolactone block copolymers as a temporary SM. Radiation crosslinking in the presence of water produces hydrogels that are removable by enzymatic decomposition. It was found that the formation of the chemical gels through crosslinking is slow and the enzymatic degradation is time-consuming and requires suitable storage of the lipases used. In addition, hydrogels have the inherent disadvantage that water may evaporate during construction of the target structure and shrinkage of the auxiliary structure may therefore occur.

This problem also occurs with hydrogels based on particulate gel formers such as phyllosilicates or silicas. For instance, experiments with aqueous dispersions of bentonites showed that it is possible to produce sufficiently stable gels that initially provide suitable support structures. However, during the printing process which in some cases may take several hours, shape loss may occur due to evaporation of water.

U.S. Pat. No. 7,368,484 B2 describes utilizing reverse thermal gelation to form auxiliary structures. This exploits reversible gel formation of copolymers under temperature elevation. However, since the strength of these gels is insufficient, partial radiation crosslinking is also required, thus hindering subsequent removal of the auxiliary structures.

WO 2014/092205 A1 mentions utilization of polyethylene glycol, in particular PEG 2000, for forming auxiliary structures. This exploits the lower melting point of PEG 2000 compared to the thermoplastic SFM. The additive manufacturing method employed here is so-called “laminated object manufacturing” in which whole layers, i.e. laminates, of the SFM are deposited. However it was found that the exclusive use of a PEG, for example PEG 2000, for site-specific simultaneous application of elastomers and support material, for example in the form of individual drops, is disadvantageous. This is because the support composition exhibits pronounced shrinkage after cooling, thus adversely affecting the dimensional fidelity of the actual component. The PEG melt moreover has low dimensional stability and droplets therefore run after site-specific application, thus making printing of fine structures impossible.

WO 2017/020971 A1 discloses an additive method for producing three-dimensional shaped bodies which is characterized in that the support material is applied via an apparatus having at least one application unit positionable in the x, y and z directions. The disadvantage of this method is that in the case of positionable application units, directional changes thereof, for example at corners, often result in an offseting of the droplets to be site-specifically applied due to the inertia of the droplets. This means that the droplet to be applied receives an impulse in the original direction of motion of the metering nozzle with the effect that the droplet is not applied with sufficient accuracy. The weight of this displacement unit may additionally become high in the case of a plurality of nozzles, thus impeding accurate control of the nozzles. Furthermore, supplying the mobile nozzles with the materials to be printed is complex in terms of construction.

The present invention accordingly had for its object to provide an additive process for producing 3-dimensional shaped bodies which allows fast, simple and cost-effective construction of support material and makes it possible to produce shaped articles with elevated printing quality.

### SUMMARY OF THE INVENTION

The object of the invention is achieved by a process wherein a fixed application unit for applying a support material is used in a site-specific 3D printing method.

### BRIEF DESCRIPTION OF THE DRAWINGS

FIG. 1 illustrates schematically one embodiment of the invention;

FIG. 2 illustrates voxel spacing in a prepared article.

### DETAILED DESCRIPTION OF THE PREFERRED EMBODIMENTS

The process according to the invention is a process for additive construction of shaped bodies (8) by site-specific application of a structure-forming material SFM (6b), characterized in that simultaneously or with a temporal offset at least one support material SM (6a) is applied in regions which remain free from SFM (6b), wherein the application of the SM (6a) is carried out via an apparatus comprising at least one fixed application unit (1a) for the SM (6a) which by site-specific application of the SM (6a) on a base plate (3) positionable in the x, y and z direction successively constructs the support structure for the shaped body (8),

wherein the SM (6a) is a composition comprising
(A) at least one polyether,
(B) at least one particulate rheological additive and
(C) optional further additives
   and after completion of construction of the shaped body (8) the SM (6a) is removed from the shaped body (8).

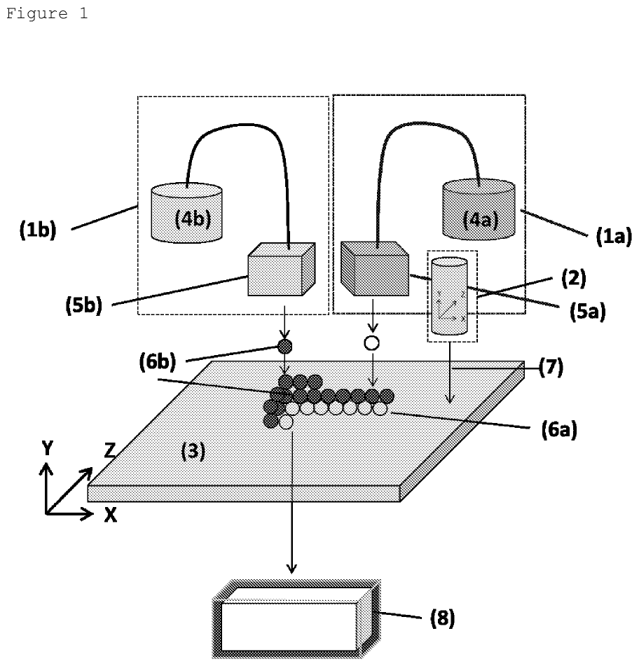

FIG. 1 is a schematic diagram showing an exemplary construction of an additive manufacturing apparatus according to the invention by means of which the process according to the invention for producing silicone elastomer parts (8) with auxiliary structures (6a) is carried out. The SM (6a) is disposed in the reservoir (4a) of an individual metering system (1a) which is pressurized and is connected to a metering nozzle (5a) via a metering conduit. The reservoir (4a) may have means allowing removal of dissolved gases by evacuation arranged upstream or downstream of it. The SFM (6b) is applied by means of a further independently operating individual metering system (1b). The individual metering system (1b) is likewise equipped with a reservoir (4b) which is connected via a metering conduit to a metering nozzle (5b). The reservoir (4b) may also have means allowing removal of dissolved gases by evacuation arranged upstream or downstream of it.

The metering nozzle (5a) and optionally also the metering nozzle (5b) are fixed in place to allow precise deposition of the SM (6a) and the SFM (6b) onto a movable base plate (3) which is preferably heatable and is positionable in the x, y and z direction and/or in the further course of shaped article formation onto previously placed SM (6a) or previously placed, optionally previously crosslinked, SFM (6b).

A surprising advantage of a positionable base plate (3) in combination with fixed metering nozzles (5a) and (5b) is an improvement in the printing accuracy and thus an elevated printing quality of the shaped article to be printed. In the case of positionable metering nozzles directional changes of the metering nozzles, for example at corners, often result in an offsetting of the droplets to be site-specifically applied due to the inertia of the droplets. This means that the droplet to be applied receives an impulse in the original direction of motion of the metering nozzle with the effect that the droplet is not applied with sufficient accuracy. This disadvantage is avoided by the positionability according to the invention of the base plate (3) in conjunction with a fixed metering nozzle (5a)/(5b). The thus-printed shaped articles accordingly have a sharper print image with fewer defects.

A further advantage of a positionable base plate (3) in conjunction with fixed metering nozzles (5a) and (5b) is a reduction in the mass to be moved. In the case of positionable (i.e. movable) metering nozzles the supply of the metering nozzles with the SM (6a) and SFM (6b) to be applied must be effected from the reservoirs (4a) and (4b) via preferably heatable, flexible feed conduits. The reservoirs (4a) and (4b) may optionally be connected to the metering nozzles (5a) and (5b) using rigid feed conduits meaning that in this case the reservoirs (4a) and (4b) have to be moved for positioning together with the metering nozzles (5a) and (5b). In both cases a considerable mass must be accurately positioned which is complex in terms of construction and thus costly, especially taking into account the high movement speeds of at least 0.1 m/s. These result in high acceleration and braking forces which oppose precise positioning of the nozzles especially in the case of directional changes as in the case of corners. It is therefore advantageous in accordance with the invention to make the base plate (3) positionable instead of the metering nozzles and to fix the metering nozzles.

A further advantage of a positionable base plate (3) in conjunction with fixed metering nozzles (5a) and (5b) is the option of employing a greater number of metering nozzles, thus making it possible to incorporate a greater number of different materials in one component, i.e. for example SM and various SFM, for example silicones of different hardness or color. It is preferably also possible to incorporate different SM, for example SM of the first and second embodiment described hereinbelow, and silicones of different hardness or color to produce a component.

In the case of positionable metering nozzles the limited space available on a displacement unit leads to restrictions in the number of installable metering nozzles.

It is also possible to have one or more radiation sources (2) for crosslinking the SFM (6b) which are preferably likewise accurately positionable in the x, y and z direction and use radiation (7) to partially or fully crosslink the SFM (6b).

It is preferable to use displacement units having a high repetition accuracy for positioning of the base plate (3). The displacement unit used for positioning the base plate (3) has an accuracy of at least ±100 μm, preferably of at least ±25 μm, in each case in all three directions. The maximum speed of the displacement units employed is decisively determined by the production time of the shaped article (8) and should therefore be at least 0.1 m/s, preferably at least 0.3 m/s, particularly preferably at least 0.4 m/s.

Preference is given to metering nozzles (5a) and (5b) that allow jetting of liquid media of intermediate to high viscosity. Contemplated as such are in particular (thermal) bubble jet and piezo printheads, wherein piezo printheads are particularly preferred. The latter enable jetting of both low-viscosity materials, wherein droplet volumes of just a few picoliters (2 pL correspond to a dot diameter of about 0.035 μm) are realizable, and intermediate- and high-viscosity materials, wherein piezo printheads having a nozzle diameter between 50 and 500 μm are preferred and droplet volumes in the nanoliter range (1 to 100 nL) are producible.

In the case of intermediate- to high-viscosity materials and especially in the case of intermediate- to high-viscosity shear-thinning materials such as the SM (6a) employed here according to the invention the described process according to the invention having fixed application units and a displaceable base plate provides the abovementioned advantages since the inherently large droplets thereof have a particularly pronounced inertia and directional changes can therefore bring about a particularly large offset.

These printheads can deposit droplets with very high metering frequency (about 1-30 kHz) with low-viscosity materials (<100 mPas), while metering frequencies of up to about 500 Hz are achievable with higher-viscosity materials (>100 mPas) depending on rheological properties (shear-thinning behavior).

The chronological sequence of construction of auxiliary structures (6a) and target structures (6b) depends strongly on the desired geometry of the shaped article (8). It may thus be more expedient or even absolutely necessary to initially construct at least parts of the auxiliary structures (6a) and subsequently produce the actual target structure (6b). However it may also be possible to produce both structures simultaneously, i.e. without a temporal offset, i.e. by simultaneous metering from two independent metering means. In some cases it is more advantageous to construct at least parts of the target structure (6b) initially and then to carry out at least partial construction of support structures (6a) subsequently. The use of all possible variants may be necessary in the case of a component having complex geometry.

In the case of applying liquid, uncrosslinked SFM (6b) such as for example acrylic resins or silicone rubber compositions these must be crosslinked to afford stable target structures (8). Crosslinking of the SFM (6b) deposited dropwise is preferably carried out using one or more electromagnetic radiation sources (2) (for example IR laser, IR emitter, UV/VIS laser, UV lamp, LED) which are preferably likewise displaceable in the x, y and z direction. The radiation sources (2) may have deflection mirrors, focusing units, beam expander systems, scanners, apertures etc. Depositing and crosslinking must be adapted to one another. The process according to the invention comprises all conceivable possibilities in this regard. For example it may be necessary to initially cover an areal region of the x,y working plane with droplets of the SFM (6b) and await leveling (merging) to only then subject this region to areal irradiation and crosslinking. It may likewise be advantageous to initially solidify the applied area only in the edge region for the purposes of contouring and subsequently effect partial crosslinking of the inner region through suitable hatching. It may also be necessary to partially or fully crosslink individual droplets immediately after placement thereof to prevent running. It may be advantageous during shaped article formation to permanently irradiate the entire working area to achieve complete crosslinking, or to expose it to the radiation only briefly to specifically bring about incomplete crosslinking (green strength) which may be associated with better adhesion of the individual layers to one another. It will therefore generally be necessary to match the parameters determining deposition and crosslinking to one another according to the crosslinking system, rheological behavior and the adhesion properties of the SFM (6b) and any other materials used.

Preferably employed as the SFM (6b) are liquid acrylates, acrylate-silicone copolymers or physical mixtures thereof, acrylate-functional silicones or pure silicone rubber materials. Preference is given to the use of acrylate-silicone copolymers or physical mixtures thereof, acrylate-functional silicones or pure silicone rubber materials, particular preference to that of acrylate-functional silicones or pure silicone rubber materials, and, in a specific embodiment, to that of silicone rubber materials, especially of radiation-crosslinking silicone rubber materials.

In order to avoid or eliminate soiling of the metering nozzles, the apparatus shown in FIG. 1 may be supplemented with an automatic metering nozzle cleaning station.

The individual metering systems may have a temperature control unit to condition the rheological behavior of the materials and/or to exploit the viscosity reduction resulting from elevated temperatures for the jetting.

It is preferable when, at least for the SM (6a) used in accordance with the invention, the individual metering system (1b), the reservoir (4b) and optionally the metering conduit are provided with temperature control units.

The individual metering system (1a) may optionally also apply the SM (6a) in the form of a thin bead, i.e. by the dispensing method. This method has advantages especially for larger, areal structures, for example in respect of printing speed.

The process according to the invention for producing support structures (6a) may be combined with all the known processes for additive construction of structures in which the SFM (6b) is site-specifically applied in liquid form. These include filament printing, dispensing, inkjet methods and jetting.

Preference is given to the dispensing and jetting of moderate- to high-viscosity, shear-thinning liquid SFM (6b) and particular preference to the dispensing and jetting of addition-crosslinking silicone elastomers and, in a specific embodiment, to the jetting of UV-activated or radiation-crosslinking silicone elastomers.

The entire apparatus outlined by way of example in FIG. 1 may also be accommodated in a vacuum chamber or inert gas chamber, for example in order to preclude UV-C radiation losses through oxygen or to avoid air pockets in the shaped article.

The printing space of the apparatus or the entire apparatus may preferably be accommodated in a chamber for excluding atmospheric humidity, wherein the chamber may either be purged with dry air from outside or the air in the chamber is dried by pumped circulation through a drying unit, for example a drying cartridge comprising a molecular sieve or a condensing unit.

The SM (6a) employed in the process according to the invention consists of the following components:
(A) at least one polyether,
(B) at least one particulate rheological additive and
(C) optional further additives

In a first embodiment the SM is composed of

50%-99% by weight of A),

1%-50% by weight of B) and

0%-25% by weight of C),

the SM according to the invention preferably being composed of

70%-95% by weight of A),

5%-30% by weight of B) and

0%-10% by weight of C).

The SM of the first embodiment preferably has shear-thinning properties, i.e. the viscosity η(γ) of the SM depends on the shear rate γ and decreases with increasing shear rate, wherein this effect is reversible and the viscosity increases again with decreasing shear rate.

The SM of the first embodiment especially has a high viscosity at low shear rate. The viscosity measured at a shear rate of 1 s⁻¹ at 25° C. by preference has a value greater than 100 Pa·s, more preferably a value between 100 Pa·s and 10,000 Pa·s, and most preferably between 100 Pa·s and 1000 Pa·s.

In particular, the SM of the first embodiment preferably has a low viscosity at high shear rate. The viscosity measured at a shear rate of 100 s⁻¹ at 25° C. by preference has a value of less than 100 Pa·s, more preferably a value between 0.1 Pa·s and 50 Pa·s, and most preferably between 1 Pa·s and 50 Pa·s.

The SM of the first embodiment especially exhibits thixotropic behavior, that is to say, for example, that the increase in shear viscosity after reducing shear rate is time-dependent. This behavior may be described by means of a structural relaxation parameter R⁹⁰(1000; 0.01). This corresponds to the time taken after termination of a high shear phase having a shear rate of 1000 s⁻¹ for shear viscosity to achieve 90% of the maximum viscosity of the subsequent rest phase having a shear rate of 0.01 s⁻¹. R⁹⁰(1000; 0.01) by preference has a value of 0.1 s to 100 s, more preferably 0.5 s to 75 s and most preferably 1 s to 50 s.

Viscosity is preferably regained according to a concave curve, i.e. curves towards the abscissa.

It is preferable when the concave viscosity increase curve exhibits a continuous decrease of the gradient dη/dt. This means that the average gradient in the first third of the curve (̅d̅η̅/̅d̅t̅)̅₁̅ is greater than the average gradient of the curve in the second third of the curve (̅d̅η̅/̅d̅t̅)̅₂̅ and that the average gradient in the second third of the curve (̅d̅η̅/̅d̅t̅)̅₂̅ is greater than the average gradient of the curve in the third third of the curve (̅d̅η̅/̅d̅t̅)̅₃̅, wherein the total time interval of the curve is defined by the magnitude of the structural relaxation parameter R⁹⁰(1000; 0.1).

It is preferable when the quotient (̅d̅η̅/̅d̅t̅)̅₁̅/(̅d̅η̅/̅d̅t̅)̅₃̅ is greater than 1, more preferably greater than 1.5, and in one specific embodiment greater than 2.

The SM of the first embodiment is further characterized in that it exhibits viscoelastic behavior and in particular exhibits viscoelastic solid properties in the linear-viscoelastic (LVE) range. This means that, within the LVE range, defined according to T. Mezger, G., The Rheology Handbook, 2nd Edn., Vincentz Network GmbH & Co. KG; Germany, 2006, 147ff., the loss factor tan δ=G″/G′ has a value of less than 1, preferably less than 0.5 and more preferably less than 0.25.

The SM in the first embodiment is further characterized in that it is a stable physical gel. This means that the plateau value of the storage modulus G′ within the LVE range at 25° C. has a value greater than 5×10³ Pa and preferably greater than 1×10⁴ Pa and more preferably greater than 2×10⁴ Pa. The gel is further characterized in that the critical flow stress τ_{crit}, i.e. the stress τ at which G′=G″, has a value of greater than 1 Pa, preferably greater than 5 Pa and more preferably greater than 25 Pa.

It is preferable when the SM employed according to the invention exhibits simple thermorheological behavior in a temperature range from 20° C. to 200° C., preferably in a temperature range from 25° C. to 150° C. and more preferably in a temperature range from 25° C. to 100° C., with the proviso that the lower value of the temperature range is at least 5° C. above the softening range of the employed polyether. This means that within this temperature range the SM employed according to the invention exhibits no changes in the character of its structure, for example no transition from a viscoelastic solid to a viscoelastic liquid.

This means in particular that the temperature dependency of the shear viscosity may be described by means of an Arrhenius plot, wherein the natural logarithm of the shear viscosity (ln η) is plotted on the y-axis and the reciprocal absolute temperature (1/T [K⁻¹]) is plotted on the x-axis. The activation energy of the flow process may be determined from the gradient by means of linear regression. It is preferable when the activation energy of the flow process of the SM employed according to the invention for a shear rate of 10 s⁻¹ is in the range from 1 to 100 kJ/mol, preferably in the range from 5 to 50 kJ/mol and more preferably in the range from 10 to 30 kJ/mol.

It is preferable when within the technically relevant temperature range the SM of the first embodiment exhibits no change in its structural character, i.e. no transition from a viscoelastic solid to a viscoelastic liquid for example. This means in particular that in the temperature range from 20° C. to 200° C., preferably in the temperature range from 20° C. to 150° C. and more preferably in the temperature range from 20° C. to 100° C. the value of the loss factor tan δ is less than 1.

This further means that in the temperature range from 20° C. to 200° C., preferably in the temperature range from 20° C. to 150° C. and more preferably in the temperature range from 20° C. to 100° C. the plateau value of the storage modulus G′ within the LVE range has a value greater than 5×10² Pa, preferably greater than 1×10³ Pa and more preferably greater than 5×10³. This further means that in the temperature range from 20° C. to 200° C., preferably in the temperature range from 20° C. to 150° C. and more preferably in the temperature range from 20° C. to 100° C. the critical flow stress τ_{crit}, i.e. the stress τ at which G′=G″, has a value greater than 1 Pa, preferably greater than 5 Pa and more preferably greater than 10 Pa.

All rheological measurements are more particularly elucidated in the example section.

In a second embodiment the SM (6a) comprises as component (A) a polyether composition comprising (A1) at least one first polyether having a solidification point of less than 35° C. and (A2) at least one second polyether having a solidification point of not less than 35° C., wherein the proportion of the second polyether (A2) based on the total weight of the polyether composition is not less than 5% by weight to not more than 70% by weight.

In the second embodiment the SM is preferably composed of

65%-99% by weight of (A),
1%-10% by weight of (B) and
0%-25% by weight of (C),
more preferably of
92%-98% by weight of (A),
2%-8% by weight of (B) and
0%-10% by weight of (C),
more preferably of
84%-96% by weight of (A),
4%-6% by weight of (B) and
0%-10% by weight of (C).

The use of a second polyether (A2) having a solidification point of not less than 35° C. in the component (A) has the result that the SM of the second embodiment has a relatively smooth surface. The use of the second polyether (A2) additionally has the result that in the cooled state (below 60° C.) the SM solidifies and thus exhibits an elevated stability compared to gels known in the prior art. At higher temperatures (above 60° C.) the particulate rheological additive helps the SM to achieve sufficient viscoelasticity and stability.

The SM of the second embodiment is preferably characterized in that it has shear-thinning and viscoelastic properties at 70° C.

Shear-thinning properties mean that the viscosity η(γ) of the SM (6a) depends on the shear rate γ and decreases with increasing shear rate, wherein this effect is reversible and the viscosity increases again with decreasing shear rate.

It is preferable when the SM of the second embodiment has a high viscosity at low shear rate at 70° C. The viscosity measured at a shear rate of 1 s⁻¹ at 70° C. by preference has a value of not less than 10 Pa·s, more preferably a value between 15 Pa·s and 1000 Pa·s, and most preferably between 20 Pa·s and 500 Pa·s, and in a specific embodiment between 25 Pa·s and 250 Pa·s.

The SM of the second embodiment preferably has a low viscosity at high shear rate at 70° C. The viscosity, measured at a shear rate of 100 s⁻¹ at 70° C., has a value of not more than 10 Pa·s, preferably a value of not less than 0.1 Pa·s to not more than 10 Pa·s, more preferably of not less than 1 Pa·s to not more than 10 Pa·s, and in a specific embodiment of not less than 1 Pa·s to not more than 7 Pa·s.

The SM of the second embodiment preferably exhibits thixotropic behavior at 70° C., that is to say, for example, that the increase in shear viscosity after reducing the shear rate from 500 s⁻¹ to 1 s⁻¹ is time-dependent. Viscosity is preferably regained according to a concave curve, i.e. curves towards the abscissa. The regaining of viscosity is preferably complete after not more than 10 s after reduction of the shear rate from 500 s⁻¹ to 1 s⁻¹. This means that instantaneous reduction of the shear rate from 500 s⁻¹ to 1 s⁻¹ causes the viscosity of the sample to reach a stable plateau value after not more than 10 s.

The SM of the second embodiment is further characterized in that it exhibits viscoelastic behavior at 70° C. and more preferably exhibits viscoelastic solid properties in the linear-viscoelastic (LVE) range. This means that, within the LVE range, defined according to T. Mezger, G., The Rheology Handbook, 2nd Edn., Vincentz Network GmbH & Co. KG; Germany, 2006, 147ff., the loss factor tan δ=G″/G′ has a value of less than 1, preferably less than 0.75 and more preferably less than 0.5.

The SM in the second embodiment is further characterized in that it is preferably a stable physical gel at 70° C. This means that the plateau value of the storage modulus G′ within the LVE range at 70° C. has a value greater than 100 Pa and is preferably in the range from 100 to 5000 Pa and more preferably in the range from 100 to 2500 Pa. The gel is further characterized in that the critical flow stress τ_{crit}, i.e. the stress τ at which G′=G″, preferably has a value of greater than 1 Pa, more preferably greater than 5 Pa and most preferably greater than 25 Pa. The storage modulus G′ may be determined by rheological measurements using a rheometer.

The SM of the second embodiment preferably have a phase transition in the temperature range from 20° C. to 60° C. That is to say the SM (6a) employed according to the invention exhibits a transition from a liquid with viscoelastic behavior to a solid upon cooling in the temperature range from 20° C. to 60° C. The solidification temperature Ts assigned to this phase transition was obtained from a temperature sweep experiment under dynamic stressing of the sample with constant deformation and frequency upon cooling in the temperature range from 70° C. to 20° C. The measured values of complex viscosity |η*|(T) were analyzed using the Boltzmann sigmoidal function. The solidification temperature Ts of the SM (6a) is in the range from not less than 20° C. to not more than 60° C., preferably in the range from not less than 25° C. to not more than 50° C. Solidification preferably takes place in a narrow temperature range, i.e. the solidification curve |η*|(T) is steep. This means that the gradient parameter dT of the Boltzmann sigmoidal function has a value of 0.1 to 1, preferably 0.25 to 0.75.

All rheological measurements are more particularly elucidated in the example section.

### Component (A)

Preferably employed as polyethers in the above-described first embodiment are polyalkylene glycols of general formula (I)

R′″—[(O—CH₂—CHR)ₙ(Z)ₖ(O—CH₂—CHR′)ₘ]—OR″ (I)

wherein
R represents hydrogen or a C1-C4 hydrocarbon, preferably hydrogen or methyl, and
R′ has the same definition as R, wherein the radicals R and R′ may be identical or different, and
R″ represents hydrogen, optionally substituted or mono- or polyunsaturated C1-C20 hydrocarbon, aryl, acyl —(O)C—R^{x} such as formyl, acetyl, benzoyl, acryloyl, methacryloyl, vinyl, glycidoxy, a polyalkylene glycol radical such as a polyethylene glycol radical or a polypropylene glycol radical having 1 to 50 repeating units, and
R′″ has the same definition as R″, wherein the radicals R″ and R′″ may be identical or different, and
R^{x} represents hydrogen, optionally substituted or mono- or polyunsaturated C1-C20 hydrocarbon or aryl, and
Z represents a monomer having more than 2 hydroxyl groups per molecule, i.e. a branching point, for example trihydric alcohols such as propanetriol or tetrahydric alcohols such as 2,2-bis(hydroxymethyl)-1,3-propanediol, wherein the hydroxyl groups in the polyalkylene glycols are etherified with the alkene glycol monomers, thus resulting in branched polyalkylene glycols having preferably 3 or 4 side chains, and
k represents 0 or 1, and
n, m represents an integer from 0 to 1000, preferably 0-500, with the proviso that the sum of n+m is an integer from 1 to 1000, preferably 5-500.

The polyalkylene glycols are preferably linear or branched, with 3 or 4 side chains per molecule.

Preference is given to polyalkylene glycols having a solidification point of

less than 100° C., more preferably less than 50° C., with polyalkylene glycols liquid at room temperature (=25° C.) being particularly preferred.

Preference is given to polyethylene glycols having a number-average molecular weight (Mn) of 200 g/mol to 10,000 g/mol.

Preference is given to polypropylene glycols having an Mn of 200 g/mol to 10,000 g/mol.

Particular preference is given to polyethylene glycols having an Mn of about 200 g/mol (PEG 200), about 400 g/mol (PEG 400), about 600 g/mol (PEG 600), and about 1000 g/mol (PEG 1000).

Particular preference is given to polypropylene glycols having an Mn of about 425 g/mol, about 725 g/mol, about 1000 g/mol, about 2000 g/mol, about 2700 g/mol and 3500 g/mol.

Preference is given to linear polyethylene glycol-polypropylene glycol copolymers having an Mn from 200 g/mol to 100,000 g/mol, more preferably having an Mn from 1000 g/mol to 50,000 g/mol, wherein these may be random or block copolymers.

Preference is given to branched polyethylene glycol-polypropylene glycol copolymers having an Mn from 200 g/mol to 100,000 g/mol, more preferably having an Mn from 1000 g/mol to 50 000 g/mol, wherein these may be random or block copolymers.

Preference is given to polyalkylene glycol monoethers, i.e. polyethylene glycol monoethers, polypropylene glycol monoethers and ethylene glycol-propylene glycol copolymer monoethers having an Mn from 1000 g/mol to 10,000 g/mol and an alkyl ether radical, such as methyl ether, ethyl ether, propyl ether, butyl ether or the like.

The polyalkylene glycols may preferably be employed in pure form or in any desired mixtures.

The second embodiment described hereinabove preferably comprises as component A:
(A1) at least one first polyether having a solidification point of less than 35° C., preferably not more than 30° C., more preferably not more than 25° C., and in particular not more than 10° C. and
(A2) at least one second polyether having a solidification point of not less than 35° C., preferably not less than 40° C., more preferably not less than 45° C., and in particular not less than 50° C., very particularly not less than 55° C.

The employed polyethers are typically commercial products marketed for example by Clariant under the trade name Polyglykol.

If polyethers solidify in a certain temperature range (solidification range) the solidification point of a polyether is to be understood as meaning the lower limit of the solidification range. The solidification points/solidification ranges of the polyethers may be determined independently thereof for example by DSC according to DIN EN ISO 11357-3. The solidification point/solidification range is determined by dynamic scanning calorimetry (DSC): Mettler-Toledo DSC 1 instrument, module type: DSC1/500 (module name: DSC1_1448)): Sample weighing: 8.5 mg, temperature range −70° C. to 150° C., heating/cooling rate 10 K/min; two runs were measured (one run consists of the following heating and cooling cycle: from −70° C. (10 K/min) to 150° C. and from 150° C. (10 K/min) to −70° C.); the second run was used for the evaluation.

The proportion of the second polyether (A2) based on the total weight of the polyether composition (A) is not less than 5% by weight to not more than 70% by weight, preferably not less than 10% by weight to not more than 65% by weight, more preferably not less than 15% by weight to not more than 60% by weight.

If the proportion of the second polyether (A2) is too low, the SM shows a lower stability in the cooled state. If the proportion of the second polyether (A2) is too high, more pronounced shrinkage occurs upon cooling of the SM.

The proportion of the first polyether (A1) based on the total weight of the polyether composition (A) is by preference not less than 30% by weight to not more than 95% by weight, more preferably not less than 35% by weight to not more than 90% by weight, and most preferably not less than 40% by weight to not more than 85% by weight.

It is preferable when the polyether composition (A) independently employs for the first polyether (A1) and the second polyether (A2) polyalkylene glycols of general formula (I)

R′″—[(O—CH₂—CHR)ₙ(Z)ₖ(O—CH₂—CHR′)ₘ]—OR″ (I)

wherein
R is hydrogen or C₁-C₄ hydrocarbon, preferably hydrogen or methyl, and
R′ has the same definition as R, wherein the radicals R and R′ may be identical or different, and
R″ represents hydrogen, optionally substituted or mono- or polyunsaturated C₁-C₂₀ hydrocarbon, aryl, acyl —(O)C—R^{x} such as formyl, acetyl, benzoyl, acryloyl, methacryloyl, vinyl, glycidoxy, a polyalkylene glycol radical such as a polyethylene glycol radical or a polypropylene glycol radical having 1 to 50 repeating units, preferably hydrogen or methyl, particularly preferably hydrogen, and
R′″ has the same definition as R″, wherein the radicals R″ and R′″ may be identical or different, and
R^{x} represents hydrogen, optionally substituted or mono- or polyunsaturated C₁-C₂₀ hydrocarbon or aryl, and
Z represents a monomer having more than 2 hydroxyl groups per molecule, i.e. a branching point, for example trihydric alcohols such as propanetriol or tetrahydric alcohols such as 2,2-bis(hydroxymethyl)-1,3-propanediol, wherein the hydroxyl groups in the polyalkylene glycols are etherified with the alkene glycol monomers, thus resulting in branched polyalkylene glycols having preferably 3 or 4 side chains, and
k represents 0 or 1, and
n, m represents an integer of not less than zero, with the proviso that n+m is not less than 1.

The polyalkylene glycols are preferably linear or branched, with 3 or 4 side chains per molecule.

In a further embodiment the polyether composition (A) may independently employ for the first polyether (A1) and the second polyether (A2) monoethers of the polyalkylene glycols defined hereinabove, preferably polyethylene glycol monoether, polypropylene glycol monoether or ethylene glycol-propylene glycol copolymer monoether, preferably having an alkyl ether radical, more preferably a C₁-C₁₀-alkyl ether radical, such as methyl ether, ethyl ether, n-propyl ether, n-butyl ether or the like.

The first polyether (A1) and the second polyether (A2) are preferably selected from the group consisting of polyethylene glycol, polypropylene glycol, polyethylene glycol-polypropylene glycol copolymers and monoethers thereof.

The polyethylene glycol-polypropylene glycol copolymers are preferably random or block copolymers.

It is particularly preferable when the first polyether (A1) is selected from the group consisting of
a polyethylene glycol or a monoether thereof having a number-average molar mass Mn of less than 1000 g/mol, preferably not more than 800 g/mol, more preferably not more than 600 g/mol, most preferably not more than 400 g/mol to not less than 200 g/mol,
a polypropylene glycol or a monoether thereof having a number-average molar mass Mn of less than 2000 g/mol, preferably not more than 1000 g/mol, more preferably not more than 750 g/mol, most particularly preferably not more than 600 g/mol to not less than 400 g/mol and
a polyethylene glycol-polypropylene glycol copolymer or a monoether thereof having a number-average molar mass Mn of less than 2000 g/mol, preferably not more than 1000 g/mol, more preferably not more than 600 g/mol to not less than 300 g/mol.

In a particularly preferred embodiment the first polyether (A1) is a polyethylene glycol having a number-average molar mass Mn of less than 1000 g/mol, preferably not more than 800 g/mol, more preferably not more than 600 g/mol, and most preferably not more than 400 g/mol to not less than 200 g/mol.

Examples of component (A1) are polyethylene glycols having an Mn of about 200 g/mol (PEG 200), about 400 g/mol (PEG 400) or about 600 g/mol (PEG 600) or polypropylene glycols having an Mn of about 425 g/mol or about 725 g/mol.

The second polyether (A2) is preferably selected from the group consisting of
a polyethylene glycol or a monoether thereof having a number-average molar mass Mn of not less than 1000 g/mol, preferably not less than 2000 g/mol, more preferably not less than 4000 g/mol, most preferably not less than 8000 g/mol to not more than 10×10⁶ g/mol and
a polyethylene glycol-polypropylene glycol copolymer or a monoether thereof having a number-average molar mass Mn of not less than 2000 g/mol, preferably not less than 4000 g/mol, more preferably not less than 8000 g/mol to not more than 10×10⁶ g/mol.

In a particularly preferred embodiment the second polyether (A2) is a polyethylene glycol having a number-average molar mass Mn of not less than 1000 g/mol, preferably not less than 2000 g/mol, more preferably not less than 4000 g/mol, most preferably not less than 8000 g/mol to not more than 10×10⁶ g/mol.

Examples of component (A2) are polyethylene glycols having an Mn of about 1000 g/mol (PEG 1000), about 4000 g/mol (PEG 4000), about 8000 g/mol (PEG 8000), and about 20,000 g/mol (PEG 20000).

Number-average molar mass Mn may be determined by end group analysis by ¹H-NMR spectroscopy or by wet chemistry methods by determination of the hydroxyl value. Determination of hydroxyl value may be carried out according to DIN 53240-2 by acetylation of the OH groups and subsequent back-titration of the acetylation solution with KOH. The acetylation time should be at least 15 min. The number-average molar mass of the polyether may then be calculated from the measured value in mg KOH/g of polyether.

For high-molecular-weight polyethers having a very low end group density, the number-average molar mass Mn/the weight-average molar mass Mw may alternatively be determined by SEC (size exclusion chromatography).

The weight-average molecular weight Mw and the number-average molecular weight Mn are determined by size exclusion chromatography (SEC) as follows: against polyethylene oxide standard 22000, in 100 mmol/1 of sodium nitrate with 10% acetonitrile, at 40° C., a flow rate of 1.0 ml/min and with triple detection (low-angle light scattering detector, refractive index detector and viscometry detector e.g. from Malvern-Viscotek) on an Ultrahydrogel 1000, 500, 250 column set from Waters Corp. USA with an injection volume of 100 μl.

### Component (B)

As particulate rheology additives the present invention preferably employs solid, finely divided inorganic particles.

The particulate rheology additives preferably have an average particle size of <1000 nm measured by photon-correlation spectroscopy on suitably dilute aqueous solutions, in particular with an average primary particle size of 5 to 100 nm, determined by optical image evaluation on TEM micrographs. It is possible that these primary particles do not exist in isolation but instead are constituents of larger aggregates and agglomerates.

The particulate rheology additives are preferably inorganic solids, in particular metal oxides, wherein silicas are particularly preferred. The specific surface area of the metal oxide is preferably from 0.1 to 1000 m²/g (measured by the BET method according to DIN 66131 and 66132), more preferably from 10 to 500 m²/g.

The metal oxide may comprise aggregates (definition according to DIN 53206) in the diameter range from 100 to 1000 nm, wherein the metal oxide comprises agglomerates (definition according to DIN 53206) constructed from aggregates which may have sizes from 1 to 1000 μm according to external shear stress (for example resulting from the measurement conditions).

For technical handling reasons the metal oxide is preferably an oxide having a proportion of covalent bonding in the metal-oxygen bond, preferably a solid-state oxide of the main and transition group elements, such as the third main group, such as boron, aluminum, gallium or indium oxide, or the fourth main group, such as silicon dioxide, germanium dioxide or tin oxide or dioxide, lead oxide or dioxide, or an oxide of the fourth transition group, such as titanium dioxide, zirconium oxide or hafnium oxide. Other examples are stable nickel, cobalt, iron, manganese, chromium or vanadium oxides.

Particular preference is given to aluminum(III) oxides, titanium(IV) oxides and silicon(IV) oxides, such as wet-chemically produced, for example precipitated silicas or silica gels, or aluminum oxides, titanium dioxides or silicon dioxides produced in processes at elevated temperature, for example pyrogenic aluminum oxides, titanium dioxides or silicon dioxides or silica.

Other particulate rheology additives are silicates, aluminates or titanates, or aluminum phyllosilicates, such as bentonites, such as montmorillonites, or smectites or hectorites.

Particular preference is given to pyrogenic silica, which is produced in a flame-assisted reaction preferably from silicon-halogen compounds or organosilicon compounds, for example from silicon tetrachloride or methyldichlorosilane, or hydrogentrichlorosilane or hydrogenmethyldichlorosilane, or other methylchlorosilanes or alkylchlorosilanes, which may also be in a mixture with hydrocarbons, or any desired volatile or sprayable mixtures of organosilicon compounds, as mentioned, and hydrocarbons, for example in a hydrogen-oxygen flame, or else a carbon monoxide-oxygen flame. Production of the silica may optionally be carried out with or without further addition of water, for example in a purification step; preference being given to no addition of water.

It is preferable when the metal oxides and in particular the silicas have a surface fractal dimension of preferably not more than 2.3, particularly preferably of not more than 2.1, especially preferably of 1.95 to 2.05, wherein the surface fractal dimension

Dₛ is defined as:

Particle surface A is proportional to the particle radius R to the power Dₛ.

The surface fractal dimension was determined by small angle x-ray scattering (SAXS).

It is preferable when the metal oxides and in particular the silicas have a mass fractal dimension Dₘ of by preference not more than 2.8, more preferably not less than 2.7, most preferably of 2.4 to 2.6. The mass fractal dimension Dₘ is defined as: Particle mass M is proportional to the particle radius R to the power Dₘ.

The mass fractal dimension was determined by small angle x-ray scattering (SAXS).

It is preferable when the particulate rheology additives (B) are nonpolar, i.e. surface-modified, especially hydrophobized, preferably silylated finely divided inorganic particles. In this connection preference is given to hydrophobic silicas, more preferably hydrophobic pyrogenic silicas.

The expression hydrophobic silica in this connection means nonpolar silicas which have been surface-modified, preferably silylated, for example those described in the laid-open specifications EP 686676 B1, EP 1433749 A1 or DE 102013226494 A1.

For the silicas used according to the invention this means that the silica surface has been hydrophobized, i.e. silylated.

It is preferable when the hydrophobic silicas employed according to the invention are modified, i.e. silylated, with organosilicon compounds, for example

(i) organosilanes or organosilazanes of formula (II)

R¹_{d}SiY_{4-d} (II)

and/or partial hydrolyzates thereof,

wherein

R¹ may be identical or different and represents a monovalent, optionally substituted, optionally mono- or polyunsaturated, optionally aromatic hydrocarbon radical having 1 to 24 carbon atoms which may be interrupted by oxygen atoms,

d represents 1, 2 or 3 and

Y may be identical or different and represents halogen, monovalent Si—N-bonded nitrogen radicals onto which a further silyl radical may be bonded, —OR² or —OC(O)OR², wherein R² represents hydrogen or a monovalent, optionally substituted, optionally mono- or polyunsaturated hydrocarbon radical which may be interrupted by oxygen atoms,

or

(ii) linear, branched or cyclic organosiloxanes composed of units of formula (III)

R³ₑ(OR⁴)_{f}SiO_{(4-e-f)/2} (III),

wherein

R³ may be identical or different and has one of the definitions specified hereinabove for R¹,

R⁴ may be identical or different and has a definition specified for R³,

e is 0, 1, 2 or 3,

f is 0, 1, 2, 3, with the proviso that the sum of e+f is ≤3 and the number of these units per molecule is at least 2,

or

mixtures of (i) and (ii) are employed.

The organosilicon compounds employable for silylation of the silicas may be for example mixtures of silanes or silazanes of formula (II), wherein preference is given to those composed of methylchlorosilanes on the one hand or alkoxysilanes and optionally disilazanes on the other.

Examples of R¹ in formula (II) are preferably methyl, octyl, phenyl and vinyl, wherein methyl and phenyl are particularly preferred.

Examples of R² are preferably methyl, ethyl, propyl and octyl, wherein methyl and ethyl are preferred.

Preferred examples of organosilanes of formula (II) are alkylchlorosilanes, such as methyltrichlorosilane, dimethyldichlorosilane, trimethylchlorosilane, octylmethyldichlorosilane, octyltrichlorosilane, octadecylmethyldichlorosilane and octadecyltrichlorosilane, methylmethoxysilanes, such as methyltrimethoxysilane, dimethyldimethoxysilane and trimethylmethoxysilane, methylethoxysilanes, such as methyltriethoxysilane, dimethyldiethoxysilane and trimethylethoxysilane, methylacetoxysilanes, such as methyltriacethoxysilane, dimethyldiacethoxysilane and trimethylacethoxysilane, phenylsilanes, such as phenyltrichlorosilane, phenylmethyldichlorosilane, phenyldimethylchlorosilane, phenyltrimethoxysilane, phenylmethyldimethoxysilane, phenyldimethylmethoxysilane, phenyltriethoxysilane, phenylmethyldiethoxysilane and phenyldimethylethoxysilane, vinylsilanes, such as vinyltrichlorosilane, vinylmethyldichlorosilane, vinyldimethylchlorosilane, vinyltrimethoxysilane, vinylmethyldimethoxysilane, vinyldimethylmethoxysilane, vinyltriethoxysilane, vinylmethyldiethoxysilane and vinyldimethylethoxysilane, disilazanes such as hexamethyldisilazane, divinyltetramethyldisilazane and bis(3,3-trifluoropropyl)tetramethyldisilazane, cyclosilazanes such as octamethylcyclotetrasilazane, and silanols such as trimethylsilanol.

Particular preference is given to methyltrichlorosilane, dimethyldichlorosilane and trimethylchlorosilane or hexamethyldisilazane.

Preferred examples of organosiloxanes of formula (III) are linear or cyclic dialkylsiloxanes having an average number of dialkylsiloxy units greater than 3. The dialkylsiloxanes are preferably dimethylsiloxanes. Particular preference is given to linear polydimethylsiloxanes having the following end groups: trimethylsiloxy, dimethylhydroxysiloxy, dimethylchlorosiloxy, methyldichlorosiloxy, dimethylmethoxysiloxy, methyldimethoxysiloxy, dimethylethoxysiloxy, methyldiethoxysiloxy, dimethylacethoxysiloxy, methyldiacethoxysiloxy and dimethylhydroxysiloxy groups, in particular having trimethylsiloxy or dimethylhydroxysiloxy end groups.

The recited polydimethylsiloxanes preferably have a viscosity at 25° C. of 2 to 100 mPa's.

The hydrophobic silicas used according to the invention have a silanol group density of by preference less than 1.8 silanol groups per nm², more preferably of not more than 1.0 silanol groups per nm² and most preferably of not more than 0.9 silanol groups per nm².

The silanol group density is determined by acid-base titration.

The residual silanol content is determined analogously to G. W. Sears et al. Analytical Chemistry 1956, 28, 1981ff by acid-base titration of the silica suspended in a 1:1 mixture of water and methanol. The titration is carried out in the range above the isoelectric point and below the pH range of dissolution of the silica. The residual silanol content in percent may accordingly be calculated by the following formula:

SiOH=SiOH(silyl)/SiOH(phil)100%

where

SiOH(phil): Titration volume from titration of untreated silica

SiOH(silyl): Titration volume from titration of silylated silica

The hydrophobic silicas employed according to the invention have a carbon content of preferably not less than 0.4% by weight of carbon, more preferably 0.5% to 15% by weight of carbon and most preferably 0.75% to 10% by weight of carbon, wherein the weight is based on the hydrophobic silica.

The carbon content is determined by elemental analysis.

Elemental analysis for carbon is carried out according to DIN ISO 10694. A CS-530 elemental analyzer from Eltra GmbH (D-41469 Neuss) can be used.

The hydrophobic silicas employed according to the invention have a methanol number of by preference of at least 30, more preferably at least 40 and most preferably at least 50.

The methanol number is the percentage of methanol that must be added to the water phase to achieve complete wetting of the silica. Complete wetting means complete sinking of the silica in the water-methanol test liquid.

The methanol number is determined as follows: Wettability with water-methanol mixtures (vol % of MeOH in water):

Shaking together an identical volume of the silica with an identical volume of water-methanol mixture
start with 0% methanol
in case of non-wetting at least a portion of the silica floats to the surface: A mixture comprising a 5 vol % higher MeOH proportion should be used
in case of wetting the entire volume of silica sinks: Proportion of MeOH (vol %) in water gives the methanol number.

The hydrophobic silicas employed according to the invention preferably have a DBP number (dibutyl phthalate number) of less than 250 g/100 g, more preferably 150 g/100 g to 250 g/100 g.

The dibutyl phthalate absorption may be measured with a RHEOCORD 90 instrument from Haake, Karlsruhe. To this end, 12 g to the nearest 0.001 g of the silicon dioxide powder are introduced into a kneading chamber, this is closed with a lid and dibutyl phthalate is metered in via a hole in the lid at a predetermined metering rate of 0.0667 ml/s. The kneader is operated at a motor speed of 125 revolutions per minute. Once the maximum torque has been reached the kneader and the DBP metering means are automatically switched off. The DBP absorption is calculated from the amount of DBP consumed and the amount of particles weighed in according to: DBP number (g/100 g)=(DBP consumption in g/weight of powder in g)×100.

The hydrophobic silicas employed according to the invention preferably have a tamped density measured according to DIN EN ISO 787-11 of 20 g/l-500 g/l, more preferably of 30-200 g/l.

As particulate rheology additives (B) it is possible to employ any desired mixtures of finely divided inorganic particles, in particular mixtures of different silicas, for example mixtures of silicas having different BET surface areas, or mixtures of silicas having different silylations or mixtures of unmodified and silylated silicas.

In the case of mixtures of silylated, i.e. hydrophobic, nonpolar silicas and unmodified, i.e. hydrophilic, polar silicas it is preferable when the proportion of the hydrophobic silicas based on the total amount of silica is at least 50 percent by weight (% by weight), preferably at least 80% by weight and more preferably at least 90% by weight.

The unmodified, i.e. hydrophilic, polar silicas preferably have a specific surface area of 0.1 to 1000 m²/g (measured by the BET method according to DIN 66131 and 66132), more preferably from 10 to 500 m²/g.

The unmodified, i.e. hydrophilic, polar silicas have a silanol group density of by preference 1.8 silanol groups per nm² to 2.5 silanol groups per nm², more preferably 1.8 silanol groups per nm² to 2.0 silanol groups per nm².

The unmodified, i.e. hydrophilic, polar silicas have a methanol number of less than 30, preferably less than 20, more preferably less than 10, and in a specific embodiment the unmodified, i.e. hydrophilic, polar silicas are completely wetted by water without addition of methanol.

The unmodified, i.e. hydrophilic, polar silicas have a tamped density measured according to DIN EN ISO 787-11 of 20 g/l-500 g/l, preferably of 30-200 g/l and particularly preferably of 30-150 g/l.

The unmodified, i.e. hydrophilic, polar silicas employed according to the invention preferably have a DBP number (dibutyl phthalate number) of less than 300 g/100 g, preferably 150 g/100 g to 280 g/100 g.

### Further Additives (C)

The SM (6a) according to the invention may comprise further functional additives, for example
colorants, such as organic or inorganic color pigments or molecularly soluble dyes;
solvents conventionally used in industry, for example water, acetone, alcohols, aromatic or aliphatic hydrocarbons;
stabilizers, such as heat stabilizers or UV stabilizers;
UV tracers, such as fluorescence dyes, for example rhodamines, fluoresceins or other tracers for the detection of residual traces of SM on components
polymers, such as polymeric rheology additives or levelling aids;
fillers, such as nonreinforcing fillers, for example fillers having a BET surface area of up to 50 m²/g, for example quartz, diatomaceous earth, calcium silicate, zirconium silicate, zeolites, aluminum oxide, titanium oxide, iron oxide, zinc oxide, barium sulfate, calcium carbonate, gypsum, silicon nitride, silicon carbide, phyllosilicates, such as mica, montmorillonites, boron nitride, glass and plastics powder.
water scavengers or desiccants, for example molecular sieves or hydratable salts such as anhydrous Na₂SO₄, having an average particle size of less than 500 μm, preferably less than 100 μm and particularly preferably less than 50 μm as measured by laser diffraction.

The SM (6a) employed according to the invention is further characterized in that silicones can spread out on the surface of the SM (6a). This means that the contact angle of a low-molecular-weight silicone oil (for example AK 100 from Wacker Chemie AG) is less than 90°, preferably less than 60°, and that more preferably spontaneous wetting of the SM occurs without any measurable contact angle.

The SM (6a) employed according to the invention is further characterized in that it is not altered by brief irradiation with electromagnetic radiation, for example with UV light in the context of radiation-crosslinking of the SFM (6b), i.e. exhibits no decomposition reactions, polymerization reactions or loss of stability.

The SM (6a) employed according to the invention is preferably characterized in that it is easily removable from the shaped body (8) mechanically or by dissolution in a solvent after hardening of the SFM (6b). This may be achieved mechanically, for example using compressed air, spinning, for example using a centrifuge, brushes, scrapers or the like. Removal may further be achieved by dissolution in a suitable solvent. Preference is given to environmentally friendly solvents which are harmless to the end user, preferably water.

The SM (6a) employed according to the invention and in particular the employed polyethers preferably have a good solubility in water. This means that at 20° C. at least 5 g of SM dissolve in 100 g of water, preferably at least 50 g of SM dissolve in 100 g of water and more preferably at least 100 g of SM dissolve in 100 g of water.

This further means that the employed polyethers dissolve to an extent of at least 5 g in 100 g of water, preferably to an extent of at least 50 g in 100 g of water and more preferably to an extent of at least 100 g of SM in 100 g of water, in each case at 20° C.

To this end the solvent is preferably warmed and/or especially the water is admixed with suitable surfactants such as anionic, cationic or neutral surfactants. The washing may optionally be carried out mechanically, for example in a suitable dishwasher.

It is preferable when the SM (6a) employed according to the invention is recycled after removal from the shaped body (8). To this end it has proven advantageous when the SM (6a) employed according to the invention has a low absorption capacity for volatile constituents from the SFM (6b), for example low-molecular-weight siloxanes in the case of silicone elastomers as the SFM (6b).

Production of the SM dispersions containing particulate rheology additives (B) comprises mixing the particulate rheology additives (B) into the polyether composition (A).

To produce the SM dispersions the particulate rheology additives (B) may be added to the liquid polyether composition (A) and distributed by wetting or by shaking, such as with a tumble mixer, or a high speed mixer, or mixed by stirring at temperatures above the solidification point of component (A2) and preferably above 70° C. At low particle concentrations below 10% by weight simple stirring is generally sufficient for incorporation of the particles (B) into the liquid (A). The incorporation and dispersing of the particles (B) into the liquid polyether composition (A) is preferably carried out at a very high shear gradient. Apparatuses suitable therefor are preferably high-speed stirrers, high-speed dissolvers, for example with peripheral velocities of 1-50 m/s, high-speed rotor-stator systems, sonolators, nips, nozzles, ball mills, etc.

This may be carried out in discontinuous or continuous processes, preference being given to continuous processes.

Suitable systems are in particular those that initially use effective stirring means to achieve the wetting and incorporation of the particulate rheology additives (B) into the polyether composition (A), for example in a closed vessel or tank, and in a second step disperse the particulate rheology additives (B) at a very high shear gradient. This can be achieved via a dispersion system in the first vessel, or by pumped circulation from the vessel into external pipelines which comprises a dispersion means, preferably with closed-circuit recycling into the vessel. This procedure may preferably be made continuous through partial recycling and partial continuous removal.

Especially suitable for dispersion of the particulate rheology additives (B) in the SM dispersion is the use of ultrasound in the range from 5 Hz to 500 kHz, preferably 10 kHz to 100 kHz, very particularly preferably 15 kHz to 50 kHz; the ultrasonic dispersion may be carried out continuously or discontinuously. This may be achieved via individual ultrasonic transmitters, such as ultrasonic tips, or in through-flow systems containing one or more ultrasonic transmitters, optionally separated via a pipeline or pipe wall.

Ultrasonic dispersion may be carried out continuously or discontinuously.

Dispersion may be carried out in conventional mixing apparatuses suitable for producing emulsions or dispersions and providing a sufficiently large supply of shear energy, for example high-speed stator-rotor stirrer equipment, for example as designed by Prof. P. Willems, known by the registered trademark “Ultra-Turrax”, or in other stator-rotor systems known by registered trademarks such as Kady, Unimix, Koruma, Cavitron, Sonotron, Netzsch or Ystral. Other processes are ultrasonic processes using, for example, US probes/transmitters or US through-flow cells or US systems such as, or analogous to, those supplied by Sonorex/Bandelin, or ball mills, for example the Dyno-Mill from WAB, CH. Further processes employ high-speed stirrers, such as blade stirrers or paddle stirrers, dissolvers such as disc dissolvers, for example from Getzmann, or mixing systems such as planetary dissolvers, paddle dissolvers or other combined apparatuses derived from dissolver systems and stirrer systems. Other suitable systems are extruders or kneaders.

The incorporation and dispersion of the particulate rheology additives (B) is preferably carried out under vacuum or includes an evacuation step.

The incorporation and dispersion of the particulate rheology additives (B) is preferably carried out at elevated temperature in a temperature range from 30° C. to 200° C., more preferably 50° C. to 150° C. and most preferably 70° C. to 100° C. The temperature increase may preferably be controlled by external heating/cooling.

It will be appreciated that the SM dispersion may also be produced by other means.

It is preferable when the SM (6a) employed according to the invention are filled into suitable metering containers (4a), such as cartridges, flow bags or the like. It is preferable when the metering containers (4a) are subsequently protected from the ingress of atmospheric moisture by welding into metallized film for example.

The SM (6a) employed according to the invention are preferably degassed before and/or during filling, for example by application of a suitable vacuum or by means of ultrasound.

It is preferable when the SM (6a) employed according to the invention are dried before filling, for example by application of a suitable vacuum at elevated temperature.

The content of free water in the employed SM (6a), i.e. water that has not been bonded to water scavengers or desiccants, is less than 10% by weight, preferably less than 5% by weight, more preferably less than 1% by weight, based on the total composition of the SM. The content of free water may be determined quantitatively for example by Karl-Fischer titration or NMR spectroscopy.

Filling of the SM (6a) employed according to the invention is preferably carried out at elevated temperature in a temperature range from 30° C. to 200° C., preferably 50° C. to 150° C. and more preferably 70° C. to 100° C.

The SM (6a) employed according to the invention are preferably discharged from the metering containers by mechanical pressure or by means of pneumatic pressure or vacuum.

Discharging of the SM (6a) employed according to the invention from the metering containers is preferably carried out at elevated temperature in a temperature range from 30° C. to 100° C., more preferably 40° C. to 100° C. and most preferably 50° C. to 100° C.

### EXAMPLES

The following examples serve to illustrate the present invention without restricting it.

### Analytical Methods for Characterizing the Silicas (Component B)

### Methanol Number

Test of wettability with water-methanol mixtures (vol % of MeOH in water): Shaking together an identical volume of the silica with an identical volume of water-methanol mixture
start with 0% methanol
in case of non-wetting at least a portion of the silica floats to the surface: A mixture comprising a 5 vol % higher MeOH proportion should be used
in case of wetting the entire volume of silica sinks: Proportion of MeOH (vol %) in water gives the methanol number.

### Carbon Content (% C)

Elemental analysis for carbon was carried out according to DIN ISO 10694 using a CS-530 elemental analyzer from Eltra GmbH (D-41469 Neuss).

### Residual Silanol Content

The residual silanol content was determined analogously to G. W. Sears et al. Analytical Chemistry 1956, 28, 1981ff by acid-base titration of the silica suspended in a 1:1 mixture of water and methanol. The titration was carried out in the range above the isoelectric point and below the pH range of dissolution of the silica. The residual silanol content in percent may accordingly be calculated by the following formula:

SiOH=SiOH(silyl)/SiOH(phil)100%

where

SiOH(phil): Titration volume from titration of untreated silica

SiOH(silyl): Titration volume from titration of silylated silica

### DBP Number

The dibutyl phthalate absorption is measured using a RHEOCORD 90 instrument from Haake, Karlsruhe. To this end, 12 g to the nearest 0.001 g of the silicon dioxide powder are introduced into a kneading chamber, this is closed with a lid and dibutyl phthalate is metered in via a hole in the lid at a predetermined metering rate of 0.0667 ml/s. The kneader is operated at a motor speed of 125 revolutions per minute. Once the maximum torque has been reached the kneader and the DBP metering means are automatically switched off. The DBP absorption is calculated from the amount of DBP consumed and the amount of particles weighed in according to: DBP number (g/100 g)=(DBP consumption in g/weight of powder in g)×100.

### Rheological Measurements

Unless otherwise stated, all measurements were made in an MCR 302 air-bearing rheometer from Anton Paar at 25° C. Measurements were made with plate-plate geometry (25 mm) with a gap width of 300 μm. Excess sample material was removed (“trimmed”) using a wooden spatula once the plates had been closed to give the gap for the test. Before commencement of the actual measurement profile the sample was subjected to a defined pre-shearing to eliminate the rheological history derived from sample application and closing of the plates to the position for the test. Pre-shearing comprised a shear phase of 60 s at a shear rate of 100 s⁻¹ followed by a rest phase of 300 s.

The shear viscosities were determined from a so-called stepped profile where the sample was sheared at a constant shear rate of 1 s⁻¹, 10 s⁻¹ and 100 s⁻¹ in each case. Measurement point duration here was 12 s (1 s⁻¹) or 10 s (10 s⁻¹, 100 s⁻¹) and the average of the final 4 data points of a block was used as the shear viscosity.

The structural relaxation parameter R⁹⁰ (1000; 0.01) or the quotient (̅d̅η̅/̅d̅t̅)̅₁̅/(̅d̅η̅/̅d̅t̅)̅₃̅ was determined from a shear rate jump test. To this end the sample is initially sheared for 60 s at a shear rate of 0.01 s⁻¹ (measurement point duration 10 s), then for 0.5 s at a shear rate of 1000 s⁻¹ (measurement point duration 0.05 s) and then for 240 s at 0.01 s⁻¹ (measurement point duration 1 s).

The plateau value of the storage modulus G′, the loss factor tan δ and the critical shear stress τ_{crit} were obtained from a dynamic deformation test in which the sample was subjected to stress at a constant angular frequency of 10 rad/s with increasing deformation amplitude with deformation in the deformation range from 0.01 to 100. Measurement point duration was 30 s with 4 measurement points per decade. The plateau value of the storage modulus G′ is the average of data points 2 to 7, with the proviso that these are within the linear-viscoelastic range, i.e. exhibit no dependency on deformation or shear stress. The value selected for the loss factor tan δ was the value at the 4th measurement point.

The solidification temperature Ts of the SM was determined by means of a temperature sweep under dynamic shear stress. To this end the sample was subjected to stepwise cooling from 70° C. to 20° C. at a cooling rate of 1.5 K/min. The sample was subjected to a constant deformation of 0.1% at a constant frequency of 10 Hz. The measurement point duration was 0.067 min. This affords the storage modulus G′(T), the loss modulus G″(T) and the complex viscosity |η*|(T), each as a function of temperature T. Plotting |η*|(T) against T affords a sigmoid curve. The Boltzmann sigmoidal function was used to determine from the curve the solidification temperature Tₛ and the steepness of the curve as follows:

The Boltzmann sigmoidal function has the form |η|*(T)=|η|*ₘₐₓ−|η|*ₘᵢₙ/1+e^{(T-T}^{₀}⁾/dT−|η|*min here.

|η|*(T) is the magnitude of complex viscosity as a function of temperature, |η|*ₘₐₓ is the plateau value of the magnitude of complex viscosity at low temperature, |η|*ₘᵢₙ is the plateau value of the magnitude of complex viscosity at high temperature, T is the temperature in ° C., T₀ is the point of inflection and defined here as the solidification temperature Ts in ° C. and dT is the gradient parameter that describes the steepness of the curve. The function was fitted to the measured values using ORIGIN 2016G software. The software-implemented Levenberg Marquardt algorithm was used as the iteration algorithm. The fitting process was automatically terminated as soon as the fit had converged and the chi-squared value of 1×10⁻⁹ was achieved. The plateau values |η|*ₘₐₓ and |η|*ₘᵢₙ were determined from the measured values by averaging the first 10 or last 10 measurement points and fixed in the course of curve fitting. The parameters T₀ and dT were released for the iteration.

3D Printer (Noninventive):

The hereinbelow-described examples of the noninventive process employed as the additive manufacturing apparatus a NEO 3D printer from German RepRap GmbH which was modified and adapted for the experiments. The thermoplastic filament metering unit originally installed in the NEO 3D printer was replaced by a jetting nozzle from Vermes Microdispensing GmbH, Otterfing, to allow dropwise deposition of relatively-high-viscosity to firm, pasty compositions such as the SM employed according to the invention.

The NEO printer was modified since it was not equipped as standard for the installation of jetting nozzles.

The Vermes jetting nozzle was integrated into the printer controller such that the start-stop signal (trigger signal) of the Vermes jetting nozzle was actuated by the GCode controller of the printer. To this end a special signal was deposited in the GCode controller. The GCode controller of the computer thus only switched the jetting nozzle on and off (metering started and stopped).

For signal transmission of the start-stop signal, the heating cable of the originally installed filament heating nozzle of the NEO printer was disconnected and connected to the Vermes nozzle.

The remaining metering parameters (metering frequency, rising, falling etc.) of the Vermes jetting nozzle were adjusted using the MDC 3200+ Microdispensing Control Unit.

The 3D printer was controlled using a computer. The software controller and the control signal connection of the 3D printer (software: “Repitier-Host”) were modified so as to allow control of not only the motion of the metering nozzle in all three spatial directions but also of the signal for droplet deposition. The displacement speed of the NEO 3D printer is 0.3 m/s and is kept constant. This means that the metering unit is not brought to a standstill even during droplet deposition. The interval between deposited droplets is controlled using the ‘delay’ parameter and is 98 ms in all experiments.

3D Printer (Inventive):

The hereinbelow-described examples of the inventive process employed as the additive manufacturing apparatus a 3D printer constructed as follows:

The 3D printer consists of a base plate movable in the x, y and z directions, wherein the 3-axis displacement unit consists of three ball screws driven by stepper motors. The metering system employed was a jetting nozzle from Vermes Microdispensing GmbH mounted vertically above the base plate to allow dropwise deposition of relatively-high-viscosity to firm, pasty compositions such as the SM employed according to the invention. The inventive 3D printer was controlled using a modified printer controller from the abovementioned NEO printer.

The Vermes jetting nozzle was integrated into the printer controller such that the start-stop signal (trigger signal) of the Vermes jetting nozzle was actuated by the GCode controller of the printer. To this end a special signal was deposited in the GCode controller. The GCode controller of the computer thus only switched the jetting nozzle on and off (metering started and stopped). For signal transmission of the start-stop signal, the heating cable of the originally installed filament heating nozzle of the NEO printer was disconnected and connected to the Vermes nozzle. The remaining metering parameters (metering frequency, rising, falling etc.) of the Vermes jetting nozzle were adjusted using the MDC 3200+ Microdispensing Control Unit. The 3D printer was controlled using a computer. The software controller and the control signal connection of the 3D printer (software: “Repitier-Host”) were modified so as to allow control of not only the motion of the base plate in all three spatial directions but also of the signal for droplet deposition. The displacement speed of the inventive 3D printer is 0.3 m/s and is kept constant. This means that the base plate is not brought to a standstill even during droplet deposition. The interval between deposited droplets is controlled using the ‘delay’ parameter of the metering nozzle and is 98 ms in all experiments.

Metering System of the Inventive and Noninventive 3D Printer:

The metering system used for the employed SM compositions was the MDV 3200 A microdispensing metering system from Vermes Microdispensing GmbH consisting of a complete system having the following components: a) MDV 3200 A nozzle unit having a connection for Luer lock cartridges which were supplied on the top of the cartridge with 3-8 bar of compressed air (hose with adapter), b) Vermes MDH-230tfl ancillary nozzle heating system on left-hand side, c) MCH30-230 cartridge heater with MCH compressed air relief for securing a hotmelt cartridge, MHC 3002 microdispensing heating controller and heating cable MCH-230tg, d) MDC 3200+ microdispensing control unit which was in turn connected to the PC controller and, by way of moving cables, to the nozzle, allowed adjustment of the metering parameters for jetting (rising, falling, open time, needle lift, delay, no pulse, heater, nozzle, distance, voxel diameter, air admission pressure at cartridge). In all examples a 200 μm nozzle was installed in the Vermes valve as a standard nozzle insert (nozzle insert N11-200).

Vertical 30 ml Luer lock cartridges which were liquid-tightly screwed onto the dispensing nozzle and supplied with compressed air were used as reservoir vessels (4a) for the SM composition (6b).

The 3D printers and the Vermes metering system were controlled with a PC and the open-source software Simplify 3D.

Conditioning the SM Compositions (6a):

The employed materials were all devolatilized before processing in a 3D printer by, in the case of B1, storing 100 g of the composition in an open PE pot in a desiccator for 3 hours under a vacuum of 10 mbar and at room temperature (=25° C.) before filling the composition into a 30 ml cartridge having a bayonet closure and sealing with a suitable plunger (plastic piston) in the absence of air. In the case of B2 the SM was melted overnight at 70° C. in a nitrogen-purged drying cabinet, filled into cartridges and centrifuged hot for 5 minutes at 2000 rpm in the absence of air. The Luer lock cartridge was then liquid-tightly screwed into the vertical cartridge holder of the Vermes metering valve with the Luer lock screw connection pointing downwards and the pressure piston on the top of the cartridge was pressurized with 3-8 bar of compressed air; the plunger in the cartridge prevents the compressed air from getting into the previously evacuated composition.

### Example 1 (B1)

In a laboratory mixer from PC Laborsystem GmbH comprising a paddle dissolver (dissolver disc diameter 60 mm) 360 g of a polyethylene glycol having an average molar mass Mn of 600 g/mol (PEG 600) were initially charged and at a temperature of 45° C. 36 g of HDK® H18 hydrophobic pyrogenic silica (obtainable from Wacker Chemie AG; for analytical data see table 3) were added portionwise with stirring over a period of about 1 h. The mixture was then dispersed at 800 rpm and 45° C. for 0.5 h and then stirred under vacuum at 800 rpm and 45° C. for a further 30 min. This afforded a clear gel having the analytical data summarized in table 1.

TABLE 1

| | Example 1 (B1) |
|---|---|
| pRA proportion (%) | 9 |
| Viscosity 1 s⁻¹ (Pa · s) | 419 |
| Viscosity 100 s⁻¹ (Pa · s) | 15 |
| R⁹⁰(1000;0.01) (s) | 10 |
| (̅d̅η̅/̅d̅t̅)̅₁̅ / (̅d̅η̅/̅d̅t̅)̅3̅ | 3.1 |
| G′(Pa) at 25° C. | 33,500 |
| tan δ (25° C.) | 0.0717 |
| τ_{crit} (Pa) at 25° C. | 220 |
| tan δ (75° C.) | 0.079 |
| G′(Pa) at 75° C. | 10 764 |

pRA = particulate rheological additive

### Example 2 (B2)

In a laboratory mixer from PC Laborsystem GmbH comprising a paddle dissolver (dissolver disc diameter 60 mm) a mixture of 356.2 g of a polyethylene glycol having an average molar mass Mn of 600 g/mol (PEG 600, solidification point: 17° C.) and 118.8 g of a polyethylene glycol having an average molar mass Mn of 20,000 g/mol (PEG 20000, solidification point: 57° C.) was initially charged and at a temperature of 70° C. 25.0 g of a hydrophobic pyrogenic silica HDK® H18 (obtainable from Wacker Chemie AG; analytical data see table 3) were added portionwise with stirring over a period of about 1 h. The mixture was subsequently dispersed under vacuum at 800 rpm at 70° C. for 1.0 h. This afforded a clear gel which at temperatures below 60° C. solidifies to a white mass and has the analytical data summarized in table 2.

TABLE 2

| | Example 2 (B2) |
|---|---|
| pRA proportion (%) | 5 |
| Viscosity 1 s⁻¹ (Pa · s) at 70° C. | 110.3 |
| Viscosity 100 s⁻¹ (Pa · s) at 70° C. | 5.8 |
| Tₛ (° C.) | 46.5 |
| dT | 0.36 |
| G′ (Pa) at 70° C. | 925 |
| tan δ at 70° C. | 0.25 |
| τ_{crit} (Pa) at 70° C. | 131.1 |

pRA = particulate rheological additive

TABLE 3

| | HDK ® H18 |
|---|---|
| Methanol number | 74 |
| % Carbon | 4.8 |
| DBP number (g/100 g) | 165 |
| Residual SiOH (nm⁻¹) | 0.36 |

### Jetting Example J1 (Noninventive)

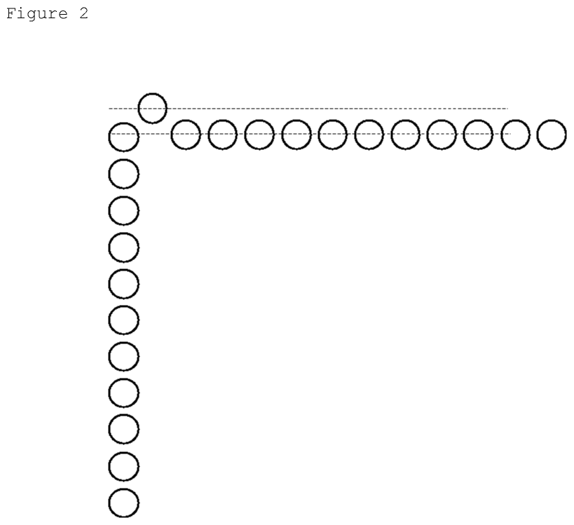

B1 was applied dropwise with the jetting nozzle parameters reported in table 4 onto a 25×75 mm glass slide as isolated individual voxels with a voxel spacing of approx. 300 μm as shown in FIG. 2. The spatial displacement between the center of the first voxel of the horizontal voxel line and the center of said line is about 55 μm.

### Jetting Example J2 (Inventive)

B1 was applied dropwise with the jetting nozzle parameters reported in table 4 onto a 25×75 mm glass slide as isolated individual voxels with a voxel spacing of approx. 300 μm as shown in FIG. 2. No spatial displacement between the center of the first voxel of the horizontal voxel line and the center of said line was observed.

### Jetting Example J3 (Noninventive)

B2 was applied dropwise with the jetting nozzle parameters reported in table 4 onto a 25×75 mm glass slide as isolated individual voxels with a voxel spacing of approx. 300 μm as shown in FIG. 2. The spatial displacement between the center of the first voxel of the horizontal voxel line and the center of said line is about 48 μm.

### Jetting Example J4 (Inventive)

B2 was applied dropwise with the jetting nozzle parameters reported in table 4 onto a 25×75 mm glass slide as isolated individual voxels with a voxel spacing of approx. 300 μm as shown in FIG. 2. No spatial displacement between the center of the first voxel of the horizontal voxel line and the center of said line was observed.

TABLE 4

| | J1 | J2 | J3 | J4 |
|---|---|---|---|---|
| 3D printer | noninventive | inventive | noninventive | inventive |
| Nozzle diameter | 200 μm | 200 μm | 200 μm | 200 μm |
| Rising (ms) | 0.3 | 0.3 | 0.4 | 0.4 |
| Falling (ms) | 0.3 | 0.3 | 0.3 | 0.3 |
| Open time (ms) | 1 | 1 | 0.5 | 0.5 |
| Needle lift (%) | 100 | 100 | 100 | 100 |
| Delay (ms) | 98 | 98 | 98 | 98 |
| Cartridge heating | Off | Off | 70 | 70 |
| (° C.) | | | | |
| Nozzle heating | Off | Off | 70 | 70 |
| (° C.) | | | | |
| Cartridge | 2 | 2 | 4 | 4 |
| admission | | | | |
| pressure (bar) | | | | |
| Voxel diameter | 570 | 600 | 450 | 420 |
| (μm) | | | | |

1.-14. (canceled)

15. A process for additive construction of shaped bodies by site-specific application of a structure-forming material SFM, comprising:
simultaneously or with a temporal offset, applying at least one support material SM in regions which remain free from SFM, wherein the application of the SM is carried out via an apparatus comprising at least one fixed application unit for the SM which by site-specific application of the SM on a base plate positionable in the x, y and z direction successively constructs the support structure for the shaped body,
wherein the SM is a composition comprising
(A) at least one polyether,
(B) at least one particulate rheological additive and
(C) optional further additives
and after completion of construction of the shaped body the SM is removed from the shaped body.

16. The process of claim 15, wherein the application of the SFM is carried out via an apparatus comprising at least one fixed application unit for the SFM which by site-specific application of the SFM on the base plate positionable in the x, y and z direction successively constructs the structure for the shaped body.

17. The process of claim 15, wherein the SM is a shear-thinning, viscoelastic composition and exhibits the following:
a shear viscosity of not more than 100 Pa·s, measured at a shear rate of 100 s−1,
a structural relaxation parameter of at least 1 s and
a storage modulus G′ of at least 5×103 Pa,
wherein the shear viscosity, the structural relaxation parameter and the storage modulus G′ are measured at 25° C. on a rheometer having plate-plate geometry, a diameter of 25 mm and a gap width of 300 μm.

18. The process of claim 17, wherein the SM contains a polyether selected from the group consisting of polyethylene glycol, polypropylene glycol, polyethylene glycol-polypropylene glycol copolymers, and monoethers thereof.

19. The process of claim 15, wherein at 70° C. the SM is a shear-thinning viscoelastic composition and contains as component (A) a polyether composition comprising
(A1) at least one first polyether having a solidification point of less than 35° C. and
(A2) at least one second polyether having a solidification point of not less than 35° C.,
wherein the solidification point is measured by DSC according to DIN EN ISO 11357-3 and the proportion of the second polyether (A2) based on the total weight of the polyether composition is not less than 5% by weight to not more than 70% by weight and the SM exhibits the following:
a shear viscosity of at most 10 Pa·s, measured at 70° C. and a shear rate of 100 s−1 on a rheometer having plate-plate geometry, a diameter of 25 mm, and a gap width of 300 μm,
a storage modulus G′ of at least 100 Pa measured at 70° C. on a rheometer having plate-plate geometry, a diameter of 25 mm, and a gap width of 300 μm and
a solidification temperature of not less than 20° C. to not more than 60° C., wherein the solidification temperature is determined on a rheometer have a plate-plate geometry, a diameter of 25 mm, and a gap width of 300 μm by means of a temperature sweep under dynamic shear stress, wherein the sample is subjected to stepwise cooling from 70° C. to 20° C. at a cooling rate of 1.5 K/min and the sample is subjected to a constant deformation of 0.1% at a constant frequency of 10 Hz.

20. The process of claim 19, wherein the first polyether (A1) and the second polyether (A2) are, independently of one another, selected from the group consisting of polyethylene glycol, polypropylene glycol, polyethylene glycol-polypropylene glycol copolymers, and monoethers thereof.

21. The process of claim 19, wherein the first polyether (A1) is selected from the group consisting of
polyethylene glycols or monoethers thereof having a number-average molar mass Mn of less than 1000 g/mol,
polypropylene glycols or a monoethers thereof having a number-average molar mass Mn of less than 2000 g/mol, and
polyethylene glycol-polypropylene glycol copolymers or monoethers thereof having a number-average molar mass Mn of less than 2000 g/mol,
wherein the number-average molar mass Mn is measured by size exclusion chromatography.

22. The process of claim 19, wherein the second polyether (A2) is selected from the group consisting of
polyethylene glycols or monoethers thereof having a number-average molar mass Mn of not less than 1000 g/mol and
polyethylene glycol-polypropylene glycol copolymers or monoethers thereof having a number-average molar mass Mn of not less than 2000 g/mol,
wherein the number-average molar mass Mn is measured by size exclusion chromatography.

23. The process of claim 19, wherein the proportion of the second polyether (A2) based on the total weight of the polyether composition (A) is not less than 10% by weight to not more than 65% by weight.

24. The process of claim 15, wherein component (B) comprises at least one hydrophobic silica having a silanol group density of less than 1.8 silanol groups per nm2 determined by acid-base titration.

25. The process of claim 15, wherein component (B) comprises at least one hydrophobic silica having a methanol number of at least 30, wherein the methanol number corresponds to the percentage proportion of methanol that must be added to a water phase to achieve complete wetting of the silica, wherein complete wetting means complete sinking of the silica in the water-methanol test liquid.

26. The process of claim 15, wherein the SM is removed from the shaped body mechanically or by dissolution in a solvent.

27. The process of claim 15, wherein the SFM is selected from the group consisting of acrylates, acrylate-silicone copolymers, acryloyl-functional silicones and silicone rubber compositions.

28. The process of claim 15, wherein the SFM is a silicone rubber composition.
